(19) United States
(12) Patent Application Publication
(10) Pub. No.: US 2022/0070307 A1
(43) Pub. Date: Mar. 3, 2022

(54) IMAGE FORMING APPARATUS

(71) Applicant: KONICA MINOLTA, INC., Tokyo (JP)

(72) Inventors: Kenichi HAYASHI, Anjo-shi (JP); Akinori KIMATA, Toyokawa-shi (JP); Noriyuki JINBO, Hamamatsu-shi (JP); Shiro UMEDA, Toyokawa-shi (JP); Yukinobu IGUCHI, Hamamatsu-shi (JP); Satoru SASAKI, Toyokawa-shi (JP)

(73) Assignee: KONICA MINOLTA, INC., Tokyo (JP)

(21) Appl. No.: 17/391,124

(22) Filed: Aug. 2, 2021

(30) Foreign Application Priority Data
Sep. 3, 2020 (JP) 2020-147965

(51) Int. Cl. H04N 1/00

(52) U.S. Cl. CPC H04N 1/00063; H04N 1/00042; H04N 1/00037; H04N 1/00018; H04N 1/0009; H04N 1/00013; H04N 1/00068

(57) ABSTRACT

An image forming apparatus includes: a state monitor that monitors an apparatus state; an electrostatic noise detector that detects electrostatic noise; and an erroneous detection determiner that determines whether or not the state monitor has erroneously detected a change in the apparatus state due to electrostatic noise from a detection result of the change in the apparatus state by the state monitor and a detection result of the electrostatic noise detector.

The entire disclosure of Japanese patent Application No. 2020-147965, filed on Sep. 3, 2020, is incorporated herein by reference in its entirety.

### BACKGROUND

### Technological Field

The present disclosure relates to an image forming apparatus, and more particularly, to a technique for determining erroneous detection of an apparatus state due to electrostatic noise.

### Description of the Related Art

When electrostatic discharge (ESD) occurs due to approach or contact of a charged object, electrostatic noise of a high-voltage pulse may enter an electronic device, which may lead to malfunction or destruction of an integrated circuit (IC). For example, in an image communication device, when a pressing roller that conveys a document while pressing the document against an image sensor is charged by friction with a recording sheet during reading of an image from the document, electric charge accumulated in the pressing roller is electrostatically discharged, so that the image sensor may be broken.

In order to address such a problem, a technique has been proposed in which a discharge member having a leaf spring shape is used to surround a pressing roller, and the discharge member is brought into pressure contact with a conductive shaft of the pressing roller, by which charges electrostatically discharged from an outer peripheral surface of the pressing roller are temporarily received by the discharge member, and discharged from the discharge member to the ground via the conductive shaft (see, for example, JP 2003-295347 A). According to this technique, it is possible to prevent the image sensor from being broken by electrostatic discharge from the pressing roller.

However, since the contact force of the discharge member to the conductive shaft cannot be increased so much in order to prevent the conductive shaft and the discharge member from being worn by rubbing, the discharge member and the conductive shaft may be separated from each other when vibration or the like occurs during rotation of the pressing roller. In addition, the surface material of the discharge member may be deteriorated, which may decrease conductivity.

In such cases, electric charges electrostatically discharged from the outer peripheral surface of the pressing roller to the discharge member cannot be released from the discharge member to the conductive shaft. Therefore, the electric charges are accumulated in the discharge member, so that the charge amount of the discharge member increases. When the electrification charge of the discharge member is electrostatically discharged to the conductive shaft as a result of an increase in the charge amount of the discharge member, electrostatic noise is generated. In addition, electrostatic noise may also occur when the electrification charge on the outer peripheral surface of the pressing roller is electrostatically discharged to the discharge member. Therefore, there is a possibility that malfunction or destruction of the integrated circuit due to intrusion of electrostatic noise is caused.

When the integrated circuit malfunctions due to electrostatic noise, it is difficult to determine whether the integrated circuit itself has failed or the malfunction has occurred due to disturbance such as electrostatic noise. In a case where the malfunction is caused by electrostatic noise, the malfunction continues despite replacement of the integrated circuit, if the occurrence of the electrostatic noise cannot be suppressed. In addition, even when it is predicted that the malfunction is caused by electrostatic noise, it is not possible to take measures to prevent the generation of electrostatic noise immediately if a generation source of the electrostatic noise cannot be specified, and thus, there is a problem that it takes time to eliminate the malfunction of the integrated circuit.

To address such a problem, for example, a technique has been proposed in which a loop antenna is installed inside an image forming apparatus and a noise frequency and a noise level of electrostatic noise are detected to determine whether the received electrostatic noise is at a failure level at which a failure of various elements constituting the image forming apparatus is undoubtedly caused, at a prediction level at which a failure may be caused, or at a normal level at which there is no possibility of an occurrence of a failure, and a warning is displayed (see JP 06-102724 A).

According to this conventional technique, when the electrostatic noise is at a normal level, it can be determined that the element itself has failed.

However, in the abovementioned conventional technique, when the electrostatic noise is at a prediction level or a failure level, it is not possible to identify whether the element has failed or a malfunction is caused by the electrostatic noise, and thus, there is a problem that it is not possible to take an appropriate measure according to the cause.

Such a problem is not limited to failure, and it is not possible to determine whether or not a change in the state of the image forming apparatus detected by a circuit that may malfunction due to the influence of electrostatic noise is caused by the electrostatic noise. Therefore, it is not possible to take appropriate measures according to the change in the apparatus state.

### SUMMARY

The present disclosure has been accomplished in view of the above problems, and an object thereof is to provide an image forming apparatus capable of determining whether a change in a state of the image forming apparatus has been erroneously detected due to an influence of electrostatic noise.

To achieve the abovementioned object, according to an aspect of the present invention, an image forming apparatus reflecting one aspect of the present invention comprises: a state monitor that monitors an apparatus state; an electrostatic noise detector that detects electrostatic noise; and an erroneous detection determiner that determines whether or not the state monitor has erroneously detected a change in the apparatus state due to electrostatic noise from a detection result of the change in the apparatus state by the state monitor and a detection result of the electrostatic noise detector.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is an external perspective view illustrating a main configuration of an image forming apparatus according to an embodiment of the present disclosure;

FIG. 2 is a diagram for describing a configuration of a sheet conveyance system included in the image forming apparatus;

FIG. 3A is an external perspective view illustrating a configuration for grounding a conveyance roller using a leaf spring;

FIG. 3B is an external perspective view illustrating a configuration for grounding a conveyance roller using a coil spring;

FIG. 4 is a block diagram illustrating a main configuration of a controller;

FIG. 5A is a block diagram illustrating a main configuration of an electrostatic noise detection circuit;

FIG. 5B is a diagram illustrating a noise waveform output from an analog reception circuit of the electrostatic noise detection circuit and a noise detection signal output from a digital processor;

FIG. 6 is a flowchart illustrating a main routine of processing executed by the controller;

FIG. 7 is a flowchart illustrating an error cause identification process (S614) executed by the controller;

FIG. 8 is a timing chart illustrating output signals of a first-stage sheet feed sensor, a timing sensor, a pre-ejection sensor, and an electrostatic noise detection circuit;

FIG. 9 is a table illustrating candidates for an electrostatic noise generation source that has generated electrostatic noise causing an erroneous detection for each sensor determined to perform erroneous detection;

FIG. 10A is a diagram for illustrating a positional relationship between a main body of the image forming apparatus and a cover unit;

FIG. 10B is an enlarged view of a portion enclosed by a broken line in FIG. 10A and illustrates a main configuration of a door opening/closing leaf spring constituting a ground circuit between the main body of the image forming apparatus and the cover unit with the cover unit being closed;

FIG. 11A is a block diagram illustrating a main configuration of a multi-level detection circuit including noise detection circuits that detect electrostatic noises at two levels which are a high level and a low level;

FIG. 11B is a block diagram illustrating a controller equipped with a CPU including an A/D conversion circuit that converts an output signal of a noise detection circuit into a multi-level digital signal;

FIG. 12 is a diagram for describing temporal changes in electrostatic noise, and illustrates noise levels when the number of sheets subjected to image formation is 10,000, 100,000, and 1,000,000;

FIG. 13 is a block diagram illustrating a configuration of a controller according to a modification of the present disclosure; and

FIG. 14 is a flowchart for describing an error cause identification process according to a modification of the present disclosure.

### DETAILED DESCRIPTION OF EMBODIMENTS

Hereinafter, one or more embodiments of an image forming apparatus according to the present invention will be described with reference to the drawings. However, the scope of the invention is not limited to the disclosed embodiments.

[1] Configuration of Image Forming Apparatus

First, the configuration of the image forming apparatus according to the present embodiment will be described.

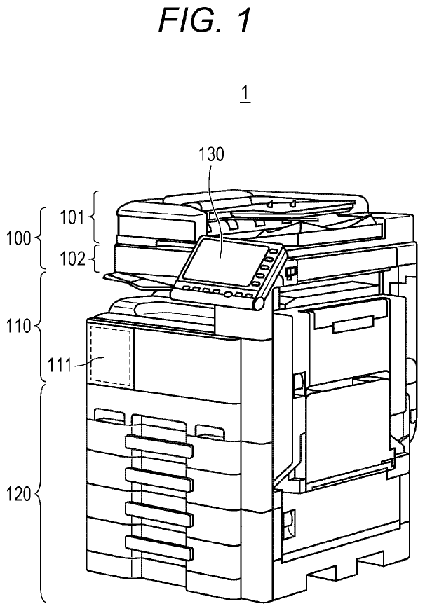

As illustrated in FIG. 1, the image forming apparatus 1 is a so-called tandem color multi-function peripheral (MFP), and includes an image reader 100, an image former 110, a sheet feeder 120, and an operation panel 130.

The image reader 100 includes an automatic document feeder 101 and a scanner 102. The automatic document feeder 101 conveys documents one by one from a stack of documents to the scanner 102 when reading the documents by a sheet-through system. The scanner 102 generates image data by reading a document being conveyed by the automatic document feeder 101 or by reading a document placed on a platen glass (not illustrated) when reading a document using a platen-set system.

The image former 110 forms an image using image data generated by the image reader 100, image data received via a communication network (not illustrated), and the like. The sheet feeder 120 supplies a recording sheet to be used by the image former 110 to form an image. The recording sheet on which the image is formed is discharged to the outside of the apparatus. The image former 110 includes a controller 111.

The controller 111 controls operation of each unit of the image forming apparatus 1. In particular, the controller 111 detects an operation state (hereinafter referred to as an “apparatus state”) of the image forming apparatus 1 by monitoring output signals of sensors provided in respective units of the image forming apparatus 1. The sensors include a later-described electrostatic noise detection circuit 411 that prevents erroneous detection of the apparatus state or detects the state of an electrostatic noise generation source by detecting electrostatic noise.

The operation panel 130 includes, for example, a touch panel or a hard key, and presents information to a user of the image forming apparatus 1 using a liquid crystal display (LCD) constituting the touch panel or receives an instruction input by the user using the touch panel or the hard key. Thus, the image forming apparatus 1 receives an image reading job and an image forming job. The image forming apparatus 1 may receive a job via a communication network (not illustrated) such as a local area network (LAN) or the Internet.

[2] Configuration of Sheet Conveyance System

The image forming apparatus 1 conveys a recording sheet to be used for image formation when executing image forming processing. Next, the configuration of a sheet conveyance system that conveys the recording sheet will be described. Note that, here, a case where the sheet feeder 120 includes two sheet feed trays will be described as an example, but the sheet feeder 120 may include only one sheet feed tray, or three or more sheet feed trays.

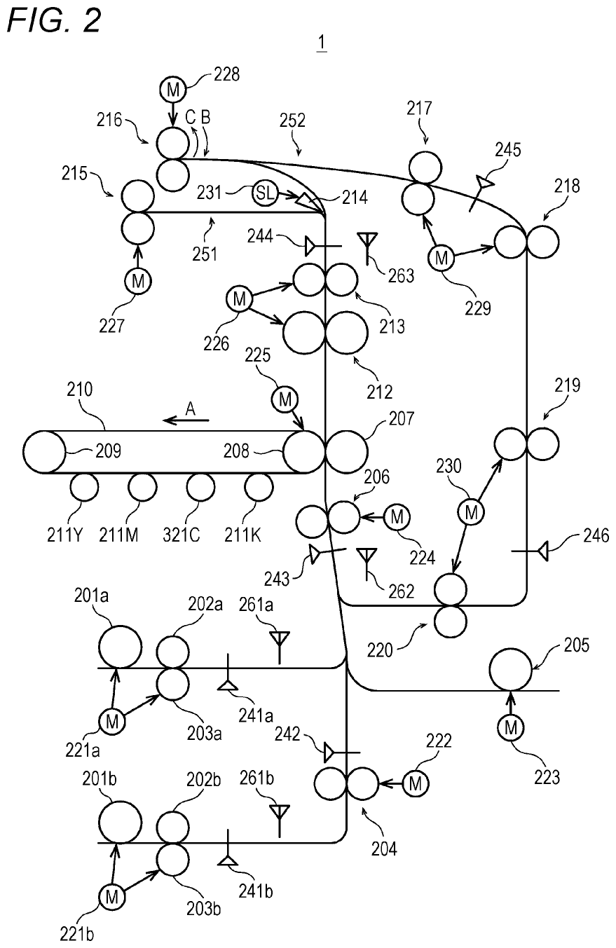

For example, when a recording sheet is fed from the sheet feed tray in the first stage, the topmost recording sheet of a stack of recording sheets stored in the sheet feed tray in the first stage is fed by a first-stage pickup roller 201a, and conveyed to a timing roller 206 by a first-stage sheet feed roller 202a with double feeding of lower recording sheets being prevented by a first-stage separation roller 203a, as shown in FIG. 2.

Both a first-stage sheet feed sensor 241a and a timing sensor 243 detect the leading end of the recording sheet. Thus, the controller 111 specifies the timings at which the leading end of the recording sheet reaches a detection position of the first-stage sheet feed sensor 241a and a detection position of the timing sensor 243. Note that the first-stage pickup roller 201a, the first-stage sheet feed roller 202a, and the first-stage separation roller 203a are rotationally driven by a first-stage sheet feed motor 221a.

Similarly, when a recording sheet is fed from the sheet feed tray in the second stage, the recording sheet is fed from the sheet feed tray in the second stage by a second-stage pickup roller 201b, and the topmost recording sheet is conveyed to a second-stage vertical conveyance roller 204 by a second-stage sheet feed roller 202b with double feeding of lower recording sheets being prevented by a second-stage separation roller 203b. The second-stage vertical conveyance roller 204 conveys the recording sheet toward the timing roller 206.

Both a second-stage sheet feed sensor 24 lb and a second-stage vertical conveyance sensor 242 detect the leading end of the recording sheet. Thus, the controller 111 specifies the timings at which the leading end of the recording sheet reaches a detection position of the second-stage sheet feed sensor 241b and a detection position of the second-stage vertical conveyance sensor 242. Note that the second-stage pickup roller 201b, the second-stage sheet feed roller 202b, and the second-stage separation roller 203b are rotationally driven by a second-stage sheet feed motor 22 lb. In addition, the second-stage vertical conveyance roller 204 is rotationally driven by a second-stage vertical conveyance motor 222.

When the recording sheet is fed from a manual multi-sheet feed tray, the recording sheet is conveyed to the timing roller 206 by rotationally driving a manual multi-sheet feed roller 205 by a manual multi-sheet feed motor 223.

Toner images of yellow (Y), magenta (M), cyan (C), and black (K) are formed on the outer peripheral surfaces of photosensitive drums 211Y, 211M, 211C, and 211K. These toner images are electrostatically transferred onto an intermediate transfer belt 210 (primary transfer) from the photosensitive drums 211Y, 211M, 211C, and 211K so that they overlap each other to form a color toner image on the outer peripheral surface of the intermediate transfer belt 210.

The intermediate transfer belt 210 is wound around a driving roller 208 and a driven roller 209. When a main motor 225 drives and rotates the driving roller 208, the intermediate transfer belt 210 moves in a direction of an arrow A. A secondary transfer roller 207 is pressed against the driving roller 208 with the intermediate transfer belt 210 interposed therebetween. Thus, a secondary transfer nip is formed. The color toner image is carried on the intermediate transfer belt 210 and conveyed to the secondary transfer nip.

The leading end of the recording sheet abuts against a conveyance nip of the timing roller 206 in a state where the timing roller 206 stops rotating The recording sheet is further conveyed with the leading end thereof abutting against the conveyance nip of the timing roller 206, and thus, a loop is formed in the recording sheet. Due to the formation of the loop, a skew of the recording sheet is corrected. Thereafter, the timing roller 206 is rotationally driven by a timing motor 224 to convey the recording sheet to the secondary transfer nip.

A secondary transfer bias is applied to the secondary transfer roller 207, and the toner image is electrostatically transferred from the intermediate transfer belt 210 to the recording sheet at the secondary transfer nip. After the toner image is thermally fixed by a fixing roller 212, the recording sheet is further conveyed by a pre-ejection roller 213. The fixing roller 212 and the pre-ejection roller 213 are rotationally driven by a fixing motor 226.

A pre-ejection sensor 244 detects the recording sheet on the downstream side of the pre-ejection roller 213 in the conveyance direction of the recording sheet. As a result, it is possible to detect a paper jam at the fixing roller 212 and the pre-ejection roller 213.

A switcher 214 is driven to swing by a solenoid actuator 231 to switch the conveyance direction of the recording sheet. Thus, the recording sheet is guided to a sheet ejection path 251 in a case where the recording sheet is ejected to the outside of the image forming apparatus 1, and is guided to a reverse roller 216 in a case where an image is formed on the back surface. A sheet ejection roller 215 is rotationally driven by a sheet ejection motor 227, and ejects the recording sheet from the sheet ejection path 251 to the outside of the image forming apparatus 1.

The reverse roller 216 first receives the recording sheet by being rotationally driven by a reverse motor 228 in the direction of an arrow B. Then, the reverse roller 216 reverses the conveyance direction of the recording sheet by being rotationally driven in the direction of an arrow C by the reverse motor 228, thereby conveying the recording sheet to a sheet reverse path 252.

In the sheet reverse path 252, automatic duplex unit (ADU) conveyance rollers 217 and 218 are rotationally driven by an ADU conveyance motor 229 to convey the recording sheet. An ADU conveyance sensor 245 detects the leading end of the recording sheet between the ADU conveyance rollers 217 and 218 on the sheet reverse path 252. When the ADU conveyance sensor 245 does not detect the leading end of the recording sheet at an appropriate timing, it is determined that a paper jam has occurred.

ADU conveyance rollers 219 and 220 are rotationally driven by an ADU conveyance motor 230 to convey the recording sheet toward the timing roller 206. An ADU conveyance sensor 246 detects the leading end of the recording sheet between the ADU conveyance rollers 219 and 220 on the sheet reverse path 252. With this process, a paper jam is detected. In this way, an image is formed on the back surface of the recording sheet, and thus, double-sided printing can be performed.

Antennas 261a, 261b, 262, and 263 are provided in the vicinity of the first-stage sheet feed sensor 241a, the second-stage sheet feed sensor 241b, the timing sensor 243, and the pre-ejection sensor 244, respectively, and receive electrostatic noise. Antennas other than the antennas 261a, 261b, 262, and 263 are not illustrated.

It is obvious that the antenna does not need to be provided for each sensor. The antenna may be provided for each electrostatic noise generation source. In addition, the number of antennas may be greater or smaller than the number of sensors or electrostatic noise generation sources. In addition, only one antenna may be provided as long as it has reception sensitivity high enough to detect all electrostatic noises that may cause erroneous detection of sensors.

[3] Electrical Ground Structure of Conveyance Roller

As described above, the image forming apparatus 1 includes conveyance rollers such as the first-stage pickup roller 201a, the first-stage sheet feed roller 202a, the first-stage separation roller 203a, the second-stage pickup roller 201b, the second-stage sheet feed roller 202b, the second-stage separation roller 203b, the second-stage vertical conveyance roller 204, the manual multi-sheet feed roller 205, the timing roller 206, the secondary transfer roller 207, the driving roller 208, the driven roller 209, the fixing roller 212, the pre-ejection roller 213, the sheet ejection roller 215, the reverse roller 216, and the ADU conveyance rollers 217, 218, 219, and 220.

When the recording sheet is conveyed, these conveyance rollers may be charged by friction with the recording sheet, or may have electric charge moving from the charged recording sheet. As described above, in order to remove electrification charge on the surface of the conveyance roller, an electrical contact point is brought into contact with the conveyance roller, and the contact point is grounded. For example, when a conductive elastic member such as a leaf spring or a coil spring is used as the electrical contact point, the electrical contact point can be brought into pressure contact with the outer peripheral surface of the conveyance roller by an elastic restoring force of the elastic member itself.

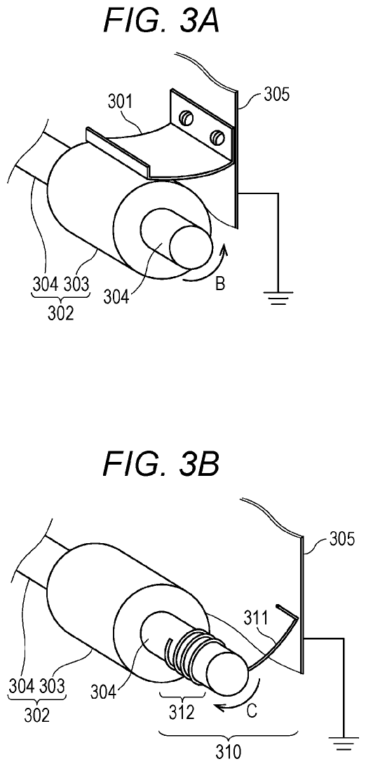

In a case where the surface of the conveyance roller is grounded using a leaf spring, a conveyance roller 302 includes a roller part 303 and a shaft part 304 as illustrated in FIG. 3A. A conductive leaf spring 301 is fixed to a metal frame 305 so as to abut on the outer peripheral surface of the roller part 303 by the elastic restoring force of the leaf spring 301 itself. The frame 305 is grounded, and thus, electrification charges of the conveyance roller 302 can be removed via the leaf spring 301.

In addition, in a case where the surface of the conveyance roller is grounded using a coil spring, a coil spring 310 having an arm part 311 and a coil part 312 is used for the conveyance roller 302 in which the roller part 303 and the shaft part 304 are both conductive. Specifically, the arm part 311 is brought into contact with the frame 305 with the coil part 312 being wound around the shaft part 304 as illustrated in FIG. 3B.

When the conveyance roller 302 is driven and rotated in the direction of the arrow C, and the shaft part 304 and the coil part 312 slide against each other, the coil spring 310 is biased to also rotate in the direction of the arrow C. Thus, when the arm part 311 is pressed against the frame 305, the rotation of the coil spring 310 in the direction of the arrow C is restricted.

Therefore, the coil part 312 is reduced in diameter by rubbing against the shaft part 304 which is rotating in the direction of the arrow C, and is brought into close contact with the shaft part 304, so that the shaft part 304 and the coil spring 310 are reliably conducted. Accordingly, the electrification charge on the outer peripheral surface of the roller part 303 is removed via the shaft part 304, the coil spring 310, and the frame 305.

In addition, a discharge member for releasing electric charge from the conveyance roller 302 to the ground may be biased toward the conveyance roller 302 using a coil spring and brought into sliding contact with the conveyance roller 302.

When the leaf spring 301 and the coil spring 310 are contaminated to lose the continuity with the conveyance roller 302 or lose the continuity with the frame 305, the electrification charge of the conveyance roller 302 cannot be removed. When electric charges accordingly continue to be accumulated in the conveyance roller 302, electrostatic noise is generated by electrostatic discharge between the leaf spring 301 or the coil spring 310 and the conveyance roller 302 or the frame 305.

[4] Configuration of Controller 111

Next, a configuration of the controller 111 will be described.

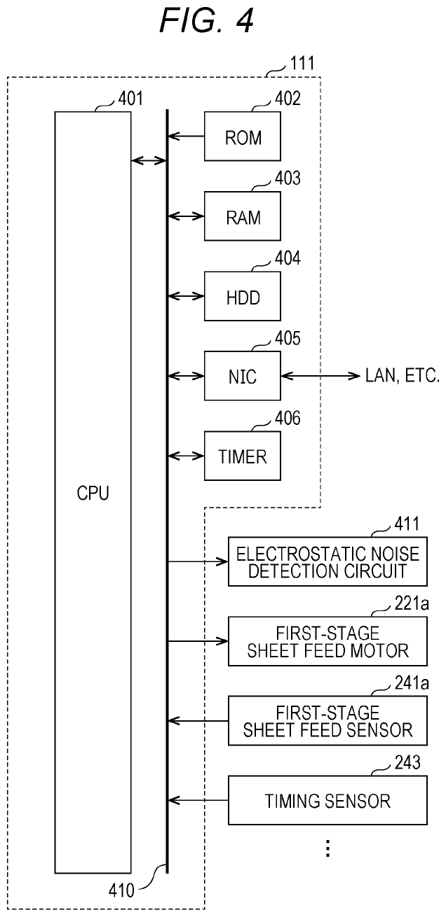

As illustrated in FIG. 4, the controller 111 has a configuration in which a central processing unit (CPU) 401, a read only memory (ROM) 402, a random access memory (RAM) 403, and the like are connected by an internal bus 410. When the image forming apparatus 1 is reset by, for example, turning on power, the CPU 401 reads a boot program from the ROM 402 and activates the boot program. The CPU 401 reads an operating system (OS) and a control program from a hard disk drive (HDD) 404 using the RAM 403 as a working storage area, and executes the OS and the control program.

A network interface card (NIC) 405 executes processing for communicating with other devices via a communication network such as a local area network (LAN) or the Internet. As a result, the image forming apparatus 1 can receive an image forming job from another apparatus or provide notification to a data center.

A network support provides maintenance and other services of the image forming apparatus 1 to users who have a network support service contract among users who use the image forming apparatus 1. In order to provide this service, the data center receives various kinds of information from the image forming apparatus 1. The data center may include a server device that receives information from the image forming apparatus 1, or may use a cloud system. A timer 406 is used to acquire a current time and measure an elapsed time.

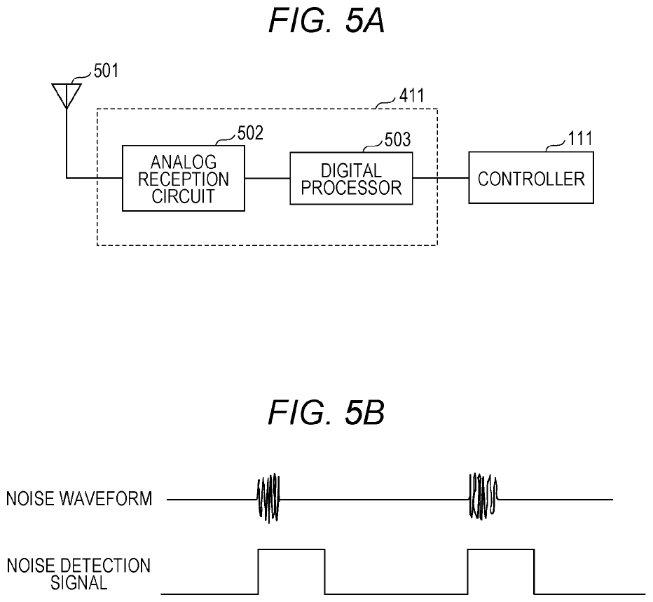

The electrostatic noise detection circuit 411 detects electrostatic noise inside the image forming apparatus 1. As illustrated in FIG. 5A, the electrostatic noise detection circuit 411 includes an analog reception circuit 502 and a digital processor 503. In the present embodiment, an antenna 501 is connected to the analog reception circuit 502, but the antenna may be mounted on the analog reception circuit 502, and another type of antenna may be used as long as it can receive electrostatic noise.

The analog reception circuit 502 incorporates an amplifier circuit. Therefore, the analog reception circuit 502 amplifies an electrostatic noise signal received using the antenna 501, and inputs the amplified signal to the digital processor 503. In the present embodiment, after a DC component of the electrostatic noise signal is removed by AC coupling, only an AC component of the electrostatic noise signal is amplified using a transistor or the like. With this processing, even if the electrostatic noise signal is weak with respect to the DC component, the electrostatic noise signal can be accurately detected.

FIG. 5B illustrates a waveform of an electrostatic noise signal input from the analog reception circuit 502 to the digital processor 503. In a case where a high voltage is applied in a state where the electrical contact point is separated, and electrostatic noise is generated by electrostatic discharge, the duration of the electrostatic noise signal is extremely short. Specifically, the electrostatic noise is often generated in a short time of several tens of nanoseconds.

The digital processor 503 includes an analog to digital (A/D) conversion circuit, and thus, converts an analog signal input from the analog reception circuit 502 into a digital signal, and maintains the digital signal in an on state for a predetermined time (for example, one clock). Specifically, when the amplitude of the input signal from the analog reception circuit 502 exceeds a threshold, the digital processor 503 determines that electrostatic noise has occurred, and then, latches the digitized electrostatic noise signal and maintains it in an on state for a predetermined time. When a predetermined time elapses after the latching, the latching is cleared and the signal is returned to the off state.

Since the electrostatic noise signal may have an extremely short duration as described above, it is necessary to use a high-speed A/D conversion circuit. Furthermore, obviously, the digital signal generated by the digital processor 503 is maintained in the on state for a period longer than the duration of the electrostatic noise signal as illustrated in FIG. 5B.

The digital processor 503 inputs such a digital signal to the controller 111. Note that the digital processor 503 may be provided in the controller 111 instead of being provided in the electrostatic noise detection circuit 411. When the CPU 401 incorporates the A/D conversion circuit, the CPU 401 may digitize the electrostatic noise signal using the A/D conversion circuit included in the CPU 401, instead of providing the digital processor 503.

In such cases, the waveform of the electrostatic noise signal may be distorted on a wiring from the analog reception circuit 502 to the digital processor 503 or the CPU 401. For this reason, in order to prevent the distortion of the signal waveform, a measure for increasing the amplification factor of the electrostatic noise signal in the analog reception circuit 502 is effective. In addition, it is desirable that the A/D conversion circuit incorporated in the CPU 401 operates at high speed.

The controller 111 determines, as the apparatus state of the image forming apparatus 1, the conveyance state of the recording sheet by referring to the sensor signals output from the first-stage sheet feed sensor 241a, the second-stage sheet feed sensor 241b, the second-stage vertical conveyance sensor 242, the timing sensor 243, the pre-ejection sensor 244, and the ADU conveyance sensors 245 and 246.

Each of these sensors may include a light emitter and a light receiver, and may detect the conveyance state of the recording sheet by detecting that light emitted from the light emitter is shielded by the recording sheet by the light receiver. Furthermore, each of these sensors may include an arm pushed down by the leading end of the recording sheet and a light shielding part swinging together with the arm, and detect the conveyance state of the recording sheet by detecting whether or not the light shielding part shields light emitted from the light emitter by the light receiver. Furthermore, other types of sensors may be applied.

When an induced current flows through the light emitter due to generation of electrostatic noise, and the lighting state of the light emitter varies, the recording sheet may be erroneously detected. In addition, when an induced current flows through the light receiver due to electrostatic noise, an output of the light receiver varies, which may cause erroneous detection.

The controller 111 also outputs control signals to the first-stage sheet feed motor 221a, the second-stage sheet feed motor 221b, the second-stage vertical conveyance motor 222, the manual multi-sheet feed motor 223, the timing motor 224, the main motor 225, the fixing motor 226, the sheet ejection motor 227, the reverse motor 228, the ADU conveyance motors 229 and 230, and the solenoid actuator 231, thereby controlling the operations of these motors and solenoid actuators.

These motors wear over time to generate metal powder having conductivity. When such metal powder accumulates inside the motor and short-circuits a conducting part in the motor, electrostatic noise may occur.

[5] Operation of Controller 111

As described above, when the output signal of each sensor varies due to the generation of electrostatic noise, the controller 111 may erroneously detect the state of the image forming apparatus 1. Therefore, in the present embodiment, it is determined whether or not the controller 111 has erroneously detected the apparatus state by detecting the electrostatic noise.

The operation of the controller 111 will be described below, taking, as an example, the case in which the output signal of the first-stage sheet feed sensor 241a that detects the recording sheet on the conveyance path of the recording sheet varies due to electrostatic noise. Notably, it is obvious that it can also be similarly determined whether or not the controller 111 erroneously detects the apparatus state in a case where the recording sheet is detected using another sensor or in a case where another apparatus state is detected.

(5-1) Main Routine

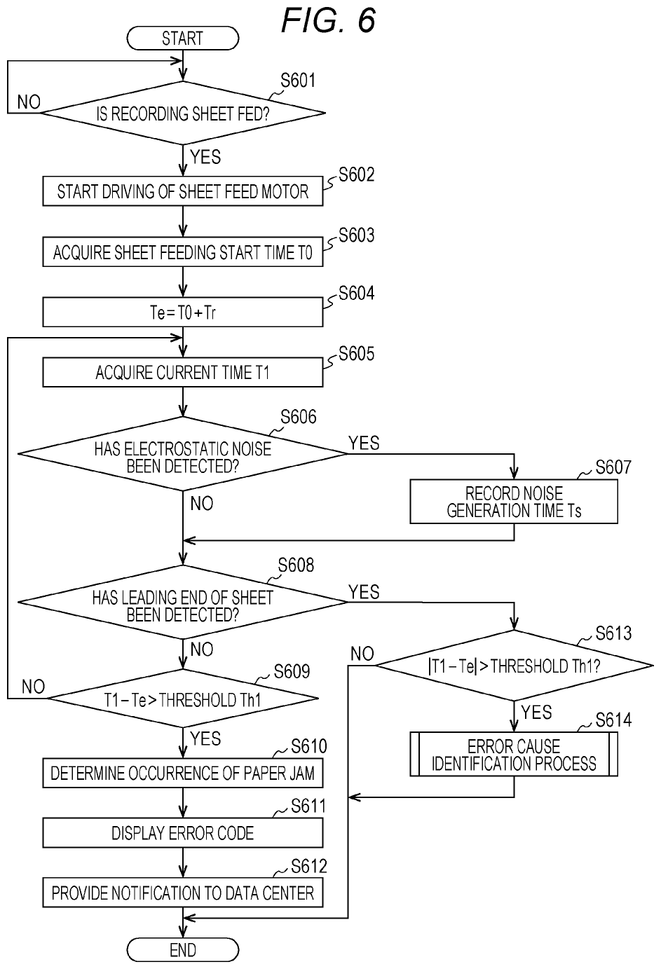

As illustrated in FIG. 6, in a case where the recording sheet is fed from the sheet feed tray in the first stage (S601: YES), the controller 111 starts driving of the first-stage sheet feed motor 221a (S602). Thus, the first-stage pickup roller 201a, the first-stage sheet feed roller 202a, and the first-stage separation roller 203a are rotationally driven, so that the feeding of the recording sheet is started.

Next, the controller 111 refers to the timer 406 to acquire the current time as a sheet feeding start time TO (S603), and calculates a scheduled sheet detection time Te by adding, to the sheet feeding start time T0, a required time Tr from when the recording sheet starts to be fed until the recording sheet reaches the sheet detection position of the first-stage sheet feed sensor 241a (S604). Note that the required time Tr may be stored in the HDD 404 in advance, or may be calculated by dividing a conveyance distance of the recording sheet from the sheet feed tray in the first stage to the sheet detection position of the first-stage sheet feed sensor 241a by a conveyance speed (system speed) of the recording sheet.

Next, the controller 111 refers to the timer 406 to acquire the current time T1 (S605), and refers to the output of the electrostatic noise detection circuit 411. When the electrostatic noise detection circuit 411 detects electrostatic noise as a result of the reference (S606: YES), the current time T1 is recorded as a noise generation time Ts (S607).

In a case where the electrostatic noise detection circuit 411 has detected no electrostatic noise (S606: NO) and after the process of step S607 is completed, the controller 111 refers to the output of the first-stage sheet feed sensor 241a. When the first-stage sheet feed sensor 241a detects the leading end of the recording sheet (S608: YES), the controller 111 calculates the time difference (absolute value of the time difference) between the current time Ti and the scheduled sheet detection time Te. If the time difference (|T1−Te|) is larger than a threshold Th1 (S613: YES), the leading end of the recording sheet is detected at a timing greatly deviated from the scheduled sheet detection time Te at which the first-stage sheet feed sensor 241a is scheduled to detect the leading end of the recording sheet.

Therefore, there is a possibility that either a paper jam has occurred or a paper jam has been erroneously detected, and in order to identify which one of them has occurred, an error cause identification process is executed (S614). Note that the detection of the recording sheet by the first-stage sheet feed sensor 241a can be said to be detection of a change in the apparatus state of the image forming apparatus 1. The controller 111 monitors the apparatus state of the image forming apparatus 1 using not only the first-stage sheet feed sensor 241a but also various sensors and other means, and detects a change in the apparatus state. This change in the apparatus state may be erroneously detected due to electrostatic noise.

In addition, the threshold Th1 represents a variation range of the scheduled sheet detection time Te in a case where the first-stage sheet feed sensor 241a normally detects the recording sheet, considering that the time at which the first-stage sheet feed sensor 241a detects the recording sheet varies due to, for example, a delay caused by slippage between each of the first-stage pickup roller 201a, the first-stage sheet feed roller 202a, and the first-stage separation roller 203a and the recording sheet.

On the other hand, when the time difference (|T1−Te|) is smaller than the threshold Th1 (S613: NO), the first-stage sheet feed sensor 241a detects the leading end of the recording sheet at a timing close to the scheduled sheet detection time Te. Therefore, the recording sheet is normally conveyed without causing any trouble such as a paper jam, and thus, the processing is ended.

When the first-stage sheet feed sensor 241a has not detected the recording sheet (S608: NO), an excess time (Ti-Te) obtained by subtracting the scheduled sheet detection time Te from the current time Ti is calculated. In a case where the excess time (T1−Te) is larger than the threshold Th1 (S609: YES), the recording sheet does not reach the recording sheet detection position of the first-stage sheet feed sensor 241a despite the long elapsed time from the scheduled sheet detection time Te at which the first-stage sheet feed sensor 241a is scheduled to detect the leading end of the recording sheet.

Therefore, it is determined that a paper jam has occurred (S610), and an error code indicating that the paper jam has occurred is displayed on the operation panel 130 (S611). Further, information indicating the occurrence of the paper jam is provided to the data center (S612), and the processing is ended. When the excess time (Ti-Te) is equal to or less than the threshold Th1 (S609: NO), the processing proceeds to step S605 and repeats the above processes.

Note that, in order to provide, for example, a maintenance service of the image forming apparatus 1 to a user who has a maintenance contract for the image forming apparatus 1, the data center receives data regarding the apparatus state from the image forming apparatus 1 via the communication network, and determines necessity and contents of the maintenance service.

(5-2) Error Cause Identification Process (S614)

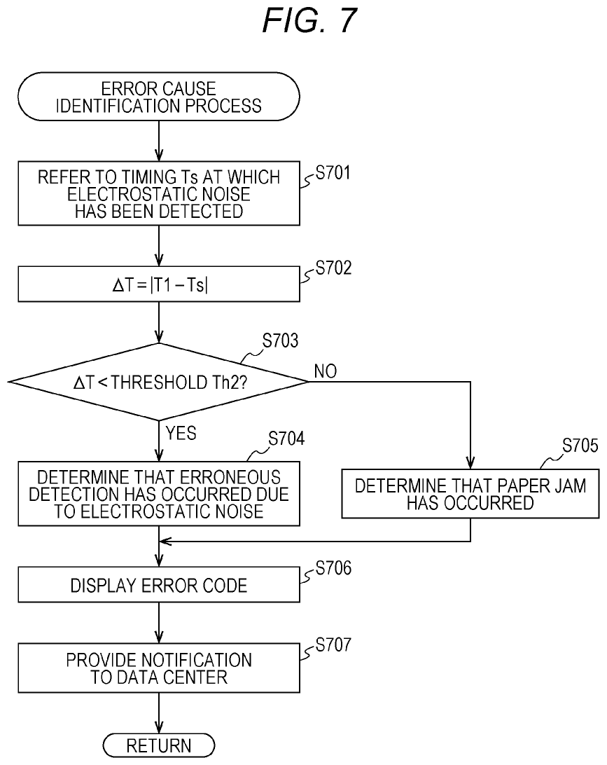

In the error cause identification process (S614), first, the noise generation time Ts recorded in step S607 of the main routine is referred to (S701), and the time difference (absolute value of the time difference) ΔT between the noise generation time Ts and the current time Ti is calculated (S702), as illustrated in FIG. 7. In a case where the time difference ΔT is smaller than a threshold Th2 (S703: YES), the timing at which the first-stage sheet feed sensor 241a detects the recording sheet is close to the timing at which the electrostatic noise occurs. Therefore, it is determined that the first-stage sheet feed sensor 241a erroneously detects the recording sheet due to the influence of the electrostatic noise (S704).

On the other hand, in a case where the time difference ΔT is equal to or greater than the threshold Th2 (S703: NO), the timing at which the first-stage sheet feed sensor 241a detects the recording sheet is not close to the timing at which the electrostatic noise occurs. Therefore, there is a low possibility that the first-stage sheet feed sensor 241a erroneously detects the recording sheet due to the influence of the electrostatic noise. Therefore, it is determined that the reason the first-stage sheet feed sensor 241a detects the recording sheet is because a paper jam occurs due to behavior disturbance of the recording sheet or the like (S705).

Thereafter, an error code corresponding to the determination result is displayed on the operation panel 130 (S706). When it is determined that the first-stage sheet feed sensor 241a has erroneously detected a recording sheet due to the influence of electrostatic noise, an error code indicating this situation is displayed on the operation panel 130, and when it is determined that a paper jam has occurred, an error code indicating the occurrence of paper jam is displayed on the operation panel 130. The determination result is also provided to the data center (S707), and then, the processing returns to the main routine.

Note that, when it is considered that displaying the error code in the operation panel 130 is not particularly advantageous to the user because there is nothing to do for the user of the image forming apparatus 1 due to the reason that there is no paper jam even if it is determined that the first-stage sheet feed sensor 241a erroneously detects the recording sheet by the influence of the electrostatic noise, it is also effective not to display the error code in the operation panel 130.

With the configuration described above, it is determined whether the first-stage sheet feed sensor 241a has erroneously detected the recording sheet according to how close the detection timing of the recording sheet by the first-stage sheet feed sensor 241a to the generation timing of the electrostatic noise. Therefore, it is possible to determine whether the paper jam has actually occurred or the erroneous detection is caused by the electrostatic noise.

[6] Method for Identifying Electrostatic Noise Generation Source

In the above embodiment, even when electrostatic noise occurs, the electrostatic noise may not affect the operation of the first-stage sheet feed sensor 241a depending on the intensity and frequency of the electrostatic noise, and thus, erroneous detection may not occur. However, when the electrostatic noise is generated, there is a possibility that a problem occurs in a generation source (referred to as an “electrostatic noise generation source” below) itself of the electrostatic noise. Therefore, the controller 111 can find a sign of a trouble in the electrostatic noise generation source by monitoring the electrostatic noise.

(6-1) Relationship Between Sensor Performing Erroneous Detection and Electrostatic Noise Generation Source

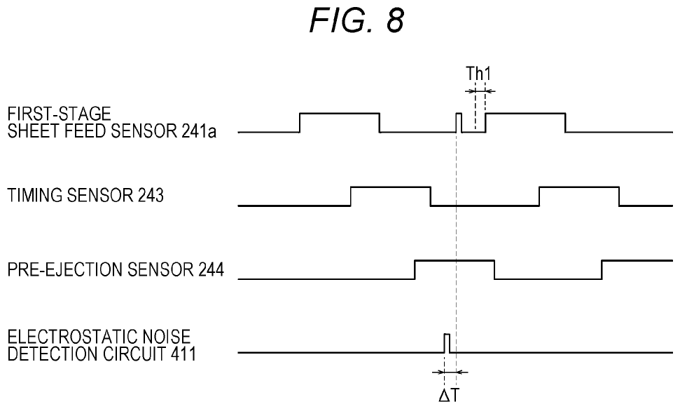

For example, if multi-feed of the recording sheets occurs when the recording sheet is fed from the sheet feed tray in the first stage, the sheet that has been fed a little together with the topmost sheet is fed during the next feeding of the recording sheet. In that case, the leading end of the sheet that has been previously fed together with the topmost sheet protrudes from the sheet feed tray, so that the first-stage sheet feed sensor 241a may detect the leading end of this sheet at the timing earlier than the scheduled sheet detection time Te by the threshold Th1. On the other hand, it is also likely that the first-stage sheet feed sensor 241a erroneously detects the recording sheet at the same timing when electrostatic noise occurs, as illustrated in FIG. 8.

In such a case, when the time difference ΔT between the timing at which the first-stage sheet feed sensor 241a detects the recording sheet and the timing at which the electrostatic noise detection circuit 411 detects the electrostatic noise is less than the threshold Th2, it can be determined that the first-stage sheet feed sensor 241a has erroneously detected the recording sheet due to the electrostatic noise.

In the example of FIG. 8, the influence of the electrostatic noise is not observed in the timing sensor 243 and the pre-ejection sensor 244 at the same timing. Therefore, it is considered that the electrostatic noise generation source that has generated the electrostatic noise is located at a position close to the first-stage sheet feed sensor 241a. That is, when the electrostatic noise is detected by the electrostatic noise detection circuit 411, it is possible to estimate the specific electrostatic noise generation source that generates the electrostatic noise by determining which sensor has erroneously detected the recording sheet.

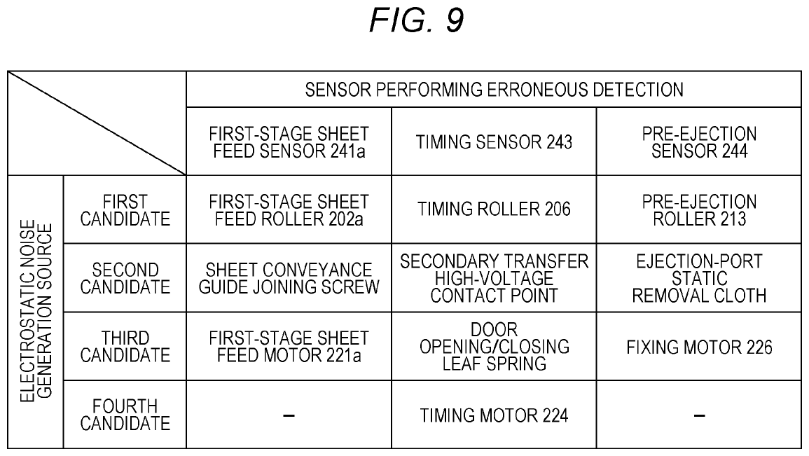

FIG. 9 is a table illustrating candidates for the electrostatic noise generation source that has generated the electrostatic noise causing the erroneous detection for each sensor determined to perform erroneous detection. Using such a table is effective for identifying the electrostatic noise generation source. In particular, in a case where it is considered that the electrostatic noise is repeatedly generated from the same electrostatic noise generation source, there is a high possibility that this electrostatic noise generation source has some problem, unlike a case where the electrostatic noise is generated sporadically from this electrostatic noise generation source. Therefore, it is considered that measures such as replacement of the electrostatic noise generation source are needed.

In the example of FIG. 9, a leaf spring, a coil spring, or the like is used for the first-stage sheet feed roller 202a, the timing roller 206, and the pre-ejection roller 213 as a biasing member for bringing a discharge member for discharging electric charges of the rollers to the ground into contact with the rollers when the rollers are charged by friction with the recording sheet or the like. When the biasing force of the biasing member decreases due to time degradation or the like, the discharge member is separated from the roller.

When the charge amount of the roller increases with the discharge member being separated, electrostatic noise is generated by electrostatic discharge. The first-stage sheet feed roller 202a, the timing roller 206, and the pre-ejection roller 213 are disposed at positions close to the first-stage sheet feed sensor 241a, the timing sensor 243, and the pre-ejection sensor 244, respectively, and thus are the first candidates for the electrostatic noise generation source.

A sheet conveyance guide that guides the recording sheet during conveyance can also be charged by friction with the recording sheet or the like. The sheet conveyance guide is grounded by being fixed to the main body of the image forming apparatus 1 with a screw. However, when a contact failure between the screw and the sheet conveyance guide or a contact failure between the screw and the main body of the image forming apparatus 1 occurs, the sheet conveyance guide is loose, so that static electricity cannot be removed from the sheet conveyance guide.

When the electrification charge of the sheet conveyance guide continues to increase in such a state, a potential difference between the sheet conveyance guide and a member other than the sheet conveyance guide such as the main body of the image forming apparatus 1 increases, and finally, electrostatic discharge occurs, which generates electrostatic noise. When the sheet conveyance guide is screwed in the vicinity of the first-stage sheet feed sensor 241a, the sheet conveyance guide joining screw can be the second candidate.

The first-stage sheet feed motor 221a, the timing motor 224, and the fixing motor 226 wear by rotational driving and generate metal powder. Furthermore, paper dust generated from the recording sheet may also have conductivity under a high-humidity condition. When such foreign matters enter the motor, noise may be generated by a short circuit.

A secondary transfer high-voltage contact point is a contact point for applying a secondary transfer bias voltage to the secondary transfer roller 207, and is, for example, a leaf spring that slides on the shaft of the secondary transfer roller 207. The secondary transfer bias voltage is high. Therefore, when the contact point is separated due to time degradation of the leaf spring or application of vibration, noise may be generated by discharge.

A contact point for applying a primary transfer bias is provided on a primary transfer roller (not illustrated) that electrostatically transfers toner images from the photosensitive drums 211Y, 211M, 211C, and 211K to the intermediate transfer belt 210. The primary transfer high-voltage contact point also has a high voltage. Therefore, when the contact point is separated due to time degradation of the leaf spring or application of vibration, it may be a noise generation source that generates noise by discharge. Therefore, depending on the distance between these contact points and the sensors, the secondary transfer high-voltage contact point and the primary transfer high-voltage contact point can also be candidates for the electrostatic noise generation source.

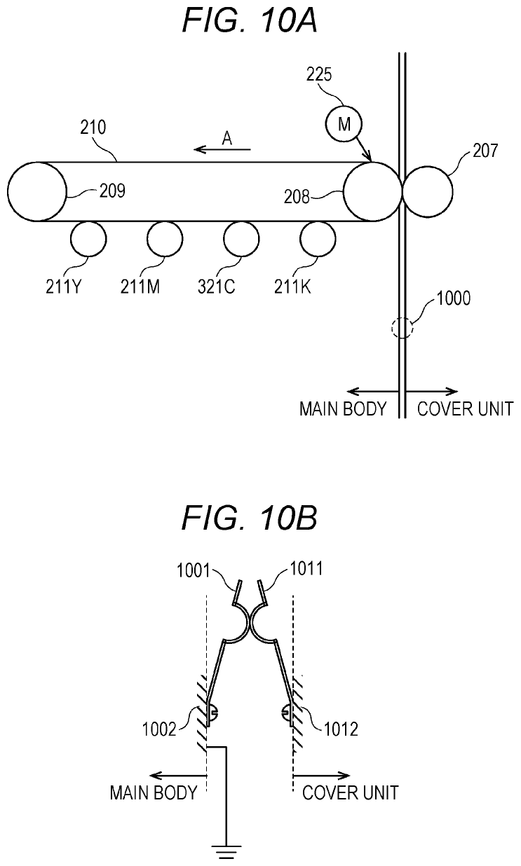

As illustrated in FIGS. 10A and 10B, a door opening/closing leaf spring constitutes a contact point located in a circuit from the secondary transfer high-voltage contact point to the ground. The door opening/closing leaf spring includes a leaf spring 1001 fixed to a main-body-side frame 1002 and a leaf spring 1011 fixed to a cover-unit-side frame 1012, and the leaf springs 1001 and 1011 are in contact with each other to form a ground circuit.

When the leaf springs 1001 and 1011 are separated due to time degradation, vibration, or the like, noise may be generated by discharge. When being provided in the vicinity of the timing sensor 243, the door opening/closing leaf spring is a candidate for an electrostatic noise generation source when the timing sensor 243 performs erroneous detection. Note that the cover unit may also serve as a duplex conveyance unit for duplex printing.

An ejection-port static removal cloth is disposed at a sheet ejection port for ejecting a recording sheet on which an image is formed to the outside of the apparatus, and removes static electricity from the recording sheet which has been charged during image formation. Therefore, the ejection-port static removal cloth itself is likely to be charged, and when electrification charge increases, it generates electrostatic noise by electrostatic discharge. In particular, when being located close to the pre-ejection sensor 244, the cloth can be a candidate for the electrostatic noise generation source that has caused erroneous detection by the pre-ejection sensor 244.

When it is determined that the sensor performs erroneous detection due to electrostatic noise, the controller 111 may display the candidates for the electrostatic noise generation source on the operation panel 130 or notify the data center of the candidates. With this configuration, when electrostatic noise is generated due to a problem in the electrostatic noise generation source, the problem of the electrostatic noise generation source can be quickly eliminated.

(6-2) Electrostatic noise detection circuit 411 and electrostatic noise generation source

The electrostatic noise detection circuit 411 may detect electrostatic noise by antennas 401 provided at a plurality of places. For the purpose of determining the cause of erroneous detection of the sensor, the plurality of antennas 401 is desirably provided inside the image forming apparatus 1.

If the antennas 401 are disposed at respective locations that can be electrostatic noise generation sources, the electrostatic noise generation source at the location corresponding to the antenna 401 having the highest intensity of the detected electrostatic noise can be identified as the electrostatic noise generation source that has caused erroneous detection. In addition, even when the number of antennas 401 is smaller than the number of electrostatic noise generation sources, the electrostatic noise generation sources can be estimated from a combination of the intensities of electrostatic noises detected for each antenna 401.

For example, four antennas are disposed inside the image forming apparatus 1. In this case, the four antennas are disposed so as not to be located on the same plane. Since electric power of radio wave is attenuated in proportion to the reciprocal of the square of distance, the distance from the antenna to the electrostatic noise generation source is proportional to the reciprocal of the square root of power of the electrostatic noise received by the antenna. Therefore, for the two antennas, the electrostatic noise generation source is present on a plane in which the distance from each antenna is proportional to the reciprocal of a square root of the power of the received electrostatic noise.

When the number of antennas is three, the electrostatic noise generation source is present on a straight line on which the distance from each antenna is proportional to the reciprocal of a square root of the reception power. Similarly, when the number of antennas is four, the position of the electrostatic noise generation source can be identified from the ratio of the reciprocal of the square root of the reception power of the electrostatic noise.

Note that, since the manner of propagation of the electrostatic noise inside the image forming apparatus 1 is different from that in a free space, the position of the electrostatic noise generation source can be estimated more accurately by adjusting the ratio of the distance from the antenna to the electrostatic noise generation source according to the specific apparatus configuration.

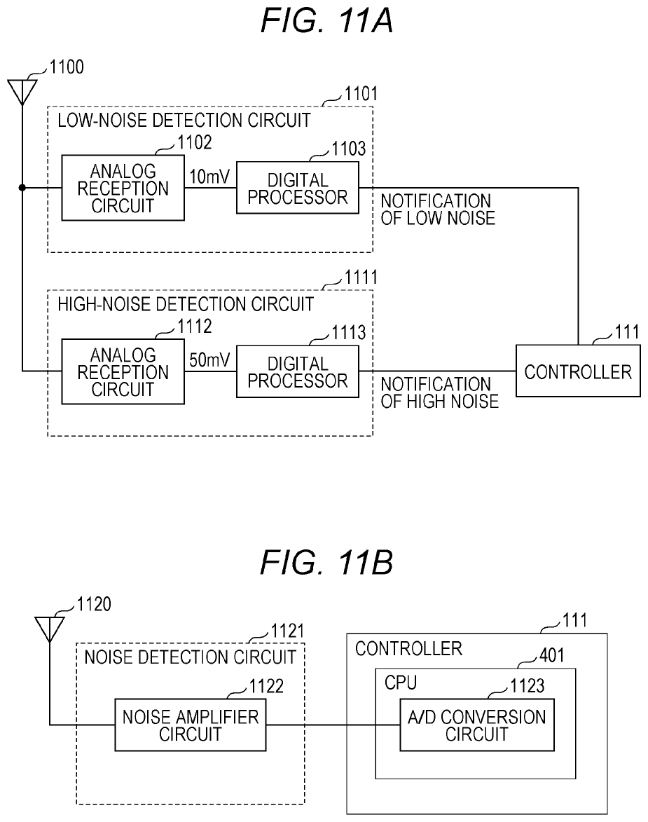

Furthermore, as illustrated in FIG. 11A, a plurality of noise detection circuits 1101 and 1111 is connected to one antenna 1100, and a difference in sensitivity to electrostatic noise is provided between the noise detection circuits 1101 and 1111. The low-noise detection circuit 1101 includes an analog reception circuit 1102 and a digital processor 1103, and when the output of the analog reception circuit 1102 is 10 mV or more, the digital processor 1103 detects electrostatic noise.

On the other hand, the high-noise detection circuit 1111 includes an analog reception circuit 1112 and a digital processor 1113, and when the output of the analog reception circuit 1112 is 50 mV or more, the digital processor 1113 detects electrostatic noise.

Obviously, the noise detection circuits do not need to have a two-stage structure including a high-noise detection circuit and a low-noise detection circuit, and may have a multi-stage structure including three or more circuits. In addition, instead of the configuration in which the outputs of the analog reception circuits 1102 and 1112 at which the digital processors 1103 and 1113 detect electrostatic noise are different from each other, the outputs of the analog reception circuits 1102 and 1112 at which the digital processors 1103 and 1113 detect electrostatic noise may be the same, and the amplification factors in the analog reception circuits 1102 and 1112 may be different from each other.

As illustrated in FIG. 11B, a noise detection circuit 1121 only has a noise amplifier circuit 1122 that amplifies a noise signal acquired from an antenna 1120 mounted on the noise detection circuit 1121, and the noise signal may be converted into a multi-bit digital signal using an A/D conversion circuit 1123 included in the CPU 401 provided in the controller 111. In addition, an A/D conversion circuit may be provided in the controller 111 separately from the CPU 401 to convert an analog output signal of the noise detection circuit 1121 into a multi-bit digital signal and then input the multi-bit digital signal to the CPU 401.

As such an A/D conversion circuit, an A/D conversion circuit capable of directly receiving the level of the analog signal output from the noise detection circuit 1121 and recognizing the intensity of the noise may be used. Note that, since the electrostatic noise has a very short duration of several tens of nanoseconds, it is desirable to use a high-speed A/D conversion circuit.

The intensity of the electrostatic noise may be detected using the electrostatic noise detection circuit and the controller 111 as described above.

With this configuration, the following is enabled. Specifically, antennas are provided near the first-stage sheet feed roller 202a, the timing roller 206, and the pre-ejection roller 213, respectively, and the intensity of electrostatic noise is detected in five levels. When the level of electrostatic noise near the first-stage sheet feed roller 202a is 1, the level of electrostatic noise near the timing roller 206 is 4, and the level of electrostatic noise near the pre-ejection roller 213 is 3, it can be determined that the distance from the electrostatic noise generation source to the timing roller 206 is the largest, the distance from the electrostatic noise generation source to the pre-ejection roller 213 is medium, and the distance from the electrostatic noise generation source to the first-stage sheet feed roller 202a is the smallest. Furthermore, in consideration of the arrangement of the antennas, the secondary transfer high-voltage contact point is the first candidate for the electrostatic noise generation source.

[7] Generation History of Electrostatic Noise

The case where only the time at which electrostatic noise has been recently detected is recorded and the case where the electrostatic noise generation source is determined from the intensity of the electrostatic noise have been described above. Meanwhile, the electrostatic noise may vary in intensity because of time degradation of the electrostatic noise generation source. In that case, recording a detection history of the intensity of the electrostatic noise is effective, because this can provide information regarding time degradation of the electrostatic noise generation source.

For this reason, the controller 111 repeats the processing of detecting the date and time when electrostatic noise has occurred and the intensity by referring to the output signal of the electrostatic noise detection circuit 411 regardless of the operation state of the image forming apparatus 1, and records the detection history of the electrostatic noise.

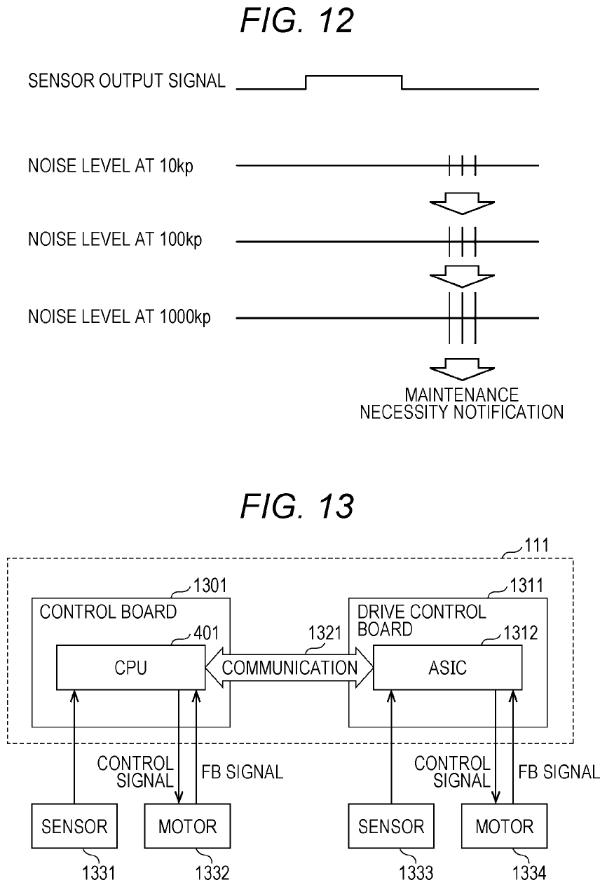

It is assumed that, as a result of the processing, a detection history as illustrated in FIG. 12 is obtained, for example. The intensity of the electrostatic noise illustrated in FIG. 12 increases as the number of sheets subjected to image formation by the image forming apparatus 1 increases to 10,000 (10 kp) and 100,000 (100 kp), and when the number of sheets subjected to image formation reaches 1,000,000 (1,000 kp), it is determined that the number exceeds a given threshold and maintenance is needed. Then, a maintenance necessity notification is transmitted from the image forming apparatus 1 to the data center.

As described above, by monitoring the intensity of the electrostatic noise, it is possible to grasp a sign of a trouble more than the occurrence of the electrostatic noise in the electrostatic noise generation source, and take measures such as part replacement before the trouble occurs, whereby the occurrence of the trouble can be prevented.

In addition, a plurality of thresholds may be set for the intensity of the electrostatic noise, and each time the electrostatic noise exceeds the threshold, a warning level may be raised, and a warning message may be displayed on the operation panel or a warning may be transmitted to the data center.

[8] Modification

While the present disclosure has been described based on the exemplary embodiment, it is obvious that the present disclosure is not limited to the exemplary embodiment described above, and the following modifications are also possible.

(8-1) The above embodiment describes the case where, as an example, a leaf spring is used as the discharge member for removing static electricity mainly from the conveyance roller. However, the present disclosure is obviously not limited thereto, and instead of or in addition to this configuration, the following configuration may be applied.

As described above, various motors are mounted on the image forming apparatus 1. For example, as illustrated in FIG. 13, a control signal is input to motors 1332 and 1334, and they rotate according to the control signal. In addition, sensors for monitoring the rotation state are provided to the motors 1332 and 1334, and feedback control of the motors 1332 and 1334 is performed by acquiring the rotation state of the motors from outputs from the sensors. When the timing at which the feedback signal changes is close to the timing at which the electrostatic noise is detected, it can be estimated that the electrostatic noise is generated from the electrostatic noise generation source in the vicinity of the motors 1332 and 1334.

In addition, the controller 111 may include a plurality of circuit boards. In a case where a drive control board 1311 on which an application specific integrated circuit (ASIC) 1312 is mounted is used separately from a control board 1301 on which the CPU 401 is mounted, a control signal or the like via a communication wiring 1321 is exchanged between the two circuit boards 1301 and 1311, because the CPU 401 needs to control the operation of the ASIC 1312. Electrostatic noise may affect such a communication signal between the circuit boards 1301 and 1311.

Therefore, when the timing at which a communication error occurs between the circuit boards 1301 and 1311 is close to the timing at which the electrostatic noise is detected, it can be estimated that the electrostatic noise is generated from the electrostatic noise generation source in the vicinity of the communication wiring 1321 between the circuit boards.

With the configurations described above, the electrostatic noise generation source that has generated the electrostatic noise can also be estimated, and thus, the configurations described above are effective to find an abnormality such as time degradation of the electrostatic noise generation source. As a result, the electrostatic noise generation source determined to be difficult to continue to operate normally may be replaced or repaired, whereby the electrostatic noise generation source can continue to operate normally, or the occurrence of the electrostatic noise can be prevented. Thus, the normal operation of the image forming apparatus 1 can be maintained

(8-2) The above embodiment describes, as an example, the case where it is determined that a change in the apparatus state has been erroneously detected in a case where the timing at which the electrostatic noise has been detected and the timing at which the change in the apparatus state of the image forming apparatus 1 has been detected are temporally close to each other. However, the present disclosure is obviously not limited thereto, and the following configuration may be applied in addition to the above configuration.

For example, suppose that there is a plurality of electrostatic noise generation sources and it is possible to estimate from which electrostatic noise generation source the electrostatic noise has been generated as described above. In that case, when the estimated electrostatic noise generation source is not included in the candidates that may cause erroneous detection in the sensor that has detected the change in the apparatus state as illustrated in FIG. 9, it may be determined that the change in the apparatus state has been normally detected even if the timing at which the electrostatic noise has been detected and the timing at which the change in the apparatus state has been detected are temporally close to each other.

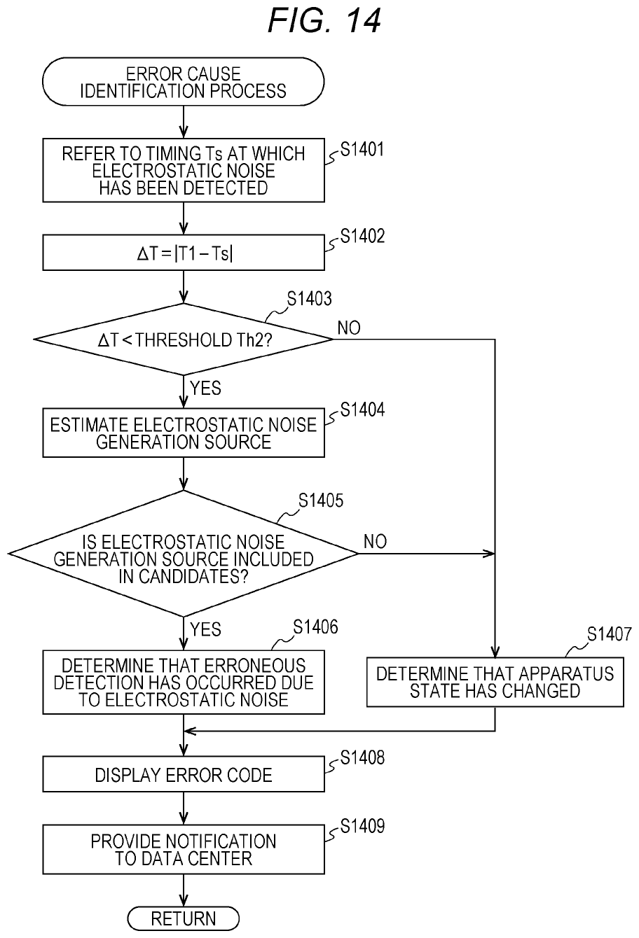

That is, as illustrated in FIG. 14, when the time difference ΔT between the current time Ti at which the change in the apparatus state is detected and the noise generation time Ts at which the electrostatic noise is detected is smaller than the threshold Th2 (S1403: YES), the electrostatic noise generation source is estimated as described above (S1404). Then, in a case where the estimated electrostatic noise generation source is included in the candidates for the electrostatic noise generation source that may cause erroneous detection of the change in the apparatus state (S1405: YES), it is determined that the change in the apparatus state has been erroneously detected due to the electrostatic noise (S1406).

In the above description, the table illustrated in FIG. 9 is used as a table in which the possibility of causing an erroneous detection of a change in the apparatus state is stored for each combination of the apparatus state and the electrostatic noise generation source. However, a table in which electrostatic noise generation sources that may cause erroneous detection of a change in the apparatus state are listed with the orders as candidates illustrated in FIG. 9 being not stored may be used. On the contrary, a table in which electrostatic noise generation sources having no possibility of causing erroneous detection of a change in the apparatus state are listed may be used.

On the other hand, when the estimated electrostatic noise generation source is not included in the candidates for the electrostatic noise generation source that may cause erroneous detection of a change in the apparatus state (S1405: NO), it is determined that the apparatus state has changed (S1407). In this way, it is possible to correctly determine that the apparatus state has changed, in a case where the electrostatic noise and the change in the apparatus state are detected at timings close to each other, but such events are independent from each other and there is no causal relationship.

Note that, as long as it can be confirmed whether the electrostatic noise generation source has a possibility of causing erroneous detection of a change in the apparatus state, the order of possibility as illustrated in the table in FIG. 9 may not be stored. That is, whether there is a possibility that a change in the apparatus state is erroneously detected may only be stored for each apparatus state.

(8-3) The above embodiment describes, as an example, the case where whether or not the image forming apparatus 1 has a change in apparatus state is detected. However, the present disclosure is obviously not limited thereto, and the magnitude of the change in the apparatus state may also be detected.

In particular, in a case where the history of the timing at which the electrostatic noise is detected and the intensity thereof is recorded, the possibility (concern level) that the change in the apparatus state is erroneously detected may be determined according to only the intensity of the electrostatic noise or the combination of the intensity of the electrostatic noise and the magnitude of the change in the apparatus state, and the determined possibility may be displayed on the operation panel 130 or provided to the data center.

With this configuration, before a change in the apparatus state is erroneously detected, a possibility of an occurrence of the erroneous detection is found. Therefore, before the erroneous detection actually occurs, it is possible to find the electrostatic noise generation source, and take measures to prevent the generation of the electrostatic noise. Accordingly, an erroneous detection of a change in the apparatus state can be prevented in advance, and thus, the normal operation of the image forming apparatus 1 can be more reliably ensured.

(8-4) The above embodiment describes, as an example, the case where the electrostatic noise detection circuit 411 includes one analog reception circuit 502 and one digital processor 503. However, the present disclosure is obviously not limited thereto, and instead of this configuration, the following configuration may be applied. For example, the electrostatic noise detection circuit 411 includes multiple analog reception circuits 502 which are connected to different antennas, respectively, and the digital processor 503 outputs digital data of a bit number equal to or larger than the number of analog reception circuits 502 to the controller 111.

The digital processor 503 outputs, to the controller 111, digital data in which bits corresponding to the analog reception circuit 502 that detects electrostatic noise and that has an output equal to or greater than a threshold are set and bits corresponding to the analog reception circuit 502 that does not detect electrostatic noise and that has an output less than the threshold are cleared. With this configuration, the controller 111 can check which antenna has detected the electrostatic noise.

Furthermore, the output value of the analog reception circuit 502 may be converted into multi-bit digital data indicating the magnitude of the output value by AD conversion instead of 1-bit data indicating whether or not the output value exceeds the threshold, and the obtained data may be output to the controller 111. With this configuration, the controller 111 can acquire the intensity of the electrostatic noise detected for each antenna.

(8-5) When there are multiple electrostatic noise generation sources that generate electrostatic noise which can be detected by the electrostatic noise detection circuit 411, it is not possible to specify which electrostatic noise generation source has generated the electrostatic noise only by the electrostatic noise detection circuit 411 detecting the electrostatic noise.

However, regarding a change which may be erroneously detected due to electrostatic noise generated from only one electrostatic noise generation source from among changes in the apparatus state of the image forming apparatus 1, it is possible to specify which electrostatic noise generation source has generated the electrostatic noise if it is found that the change has been erroneously detected.

In addition, in a case where there is only one electrostatic noise generation source that generates electrostatic noise that simultaneously causes erroneous detections of a plurality of types of changes, it is possible to specify which electrostatic noise generation source has generated the electrostatic noise if it is found that the plurality of types of changes has been erroneously detected at the same time.

Therefore, if the controller 111 stores in advance a combination of a pattern indicating which change is erroneously detected among a plurality of types of changes in the apparatus state and an electrostatic noise generation source that generates electrostatic noise which causes erroneous detection of the change, it is possible to specify the electrostatic noise generation source from the pattern of erroneous detection. If the status of generation of electrostatic noise can be recognized for each electrostatic noise generation source as described above, it is possible to diagnose the time degradation, the life, and the like for each electrostatic noise generation source and appropriately execute maintenance. Therefore, the availability and reliability of the image forming apparatus 1 can be improved.

(8-6) The above embodiment describes, as an example, the case where a change in the apparatus state of the image forming apparatus 1 is erroneously detected due to electrostatic noise. However, the present disclosure is obviously not limited thereto. In a case where a change in the apparatus state is erroneously detected due to a factor other than electrostatic noise, it may be determined that the change in the apparatus state is erroneously detected when the occurrence of the cause of the erroneous detection is also detected during the detection of the change in the apparatus state.

In addition, in a case where there are multiple causes of the erroneous detection, it is also possible to estimate which generation source has generated the cause of the erroneous detection on the basis of which apparatus state has been erroneously detected to be changed. Therefore, it is possible to diagnose the deterioration status of the generation source and the like by recognizing the status of occurrence of the cause of the erroneous detection for each generation source.

For example, the present disclosure can be applied to a case where erroneous detection of an apparatus state by a mechanical sensor occurs due to vibration generated by wear, deformation, or the like of a mechanical part, as it is for electrostatic noise.

(8-7) The above embodiment describes, as an example, the case where the image forming apparatus 1 is a color multi-function peripheral of a tandem system, but the present disclosure is obviously not limited thereto, and the image forming apparatus 1 may be a color multi-function peripheral of a system other than the tandem system, or may be a monochrome multi-function peripheral. In addition, similar effects can be obtained by applying the present disclosure to a single-function device such as a printer device, a copying machine including a scanner, and a facsimile device having a facsimile communication function.

The image forming apparatus according to the present disclosure is useful as an apparatus capable of determining erroneous detection of an apparatus state due to electrostatic noise.

According to an embodiment of the present invention, with this configuration, it can be determined whether a change in the apparatus state of the image forming apparatus has actually occurred or has been erroneously detected due to electrostatic noise. Therefore, it is possible to prevent a user from being notified of wrong information indicating that the change in the apparatus state has occurred, even though the change in the apparatus state has not actually occurred.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
a state monitor that monitors an apparatus state;
an electrostatic noise detector that detects electrostatic noise; and
an erroneous detection determiner that determines whether or not the state monitor has erroneously detected a change in the apparatus state due to electrostatic noise from a detection result of the change in the apparatus state by the state monitor and a detection result of the electrostatic noise detector.

2. The image forming apparatus according to claim 1,
wherein the erroneous detection determiner performs the determination on the basis of a result of comparison between a timing at which the state monitor detects a change in the apparatus state and a timing at which the electrostatic noise detector detects electrostatic noise.

3. The image forming apparatus according to claim 1, further comprising
a plurality of electrostatic noise generation sources that generates electrostatic noise,
wherein the state monitor monitors a plurality of types of apparatus states, and
the image forming apparatus includes an electrostatic noise generation source estimator that, when the electrostatic noise detector detects electrostatic noise, estimates an electrostatic noise generation source that has generated the electrostatic noise according to which one of the apparatus states has been determined to be erroneously detected to be changed by the state monitor from among the plurality of types of apparatus states.

4. The image forming apparatus according to claim 1, further comprising
a plurality of electrostatic noise generation sources that generates electrostatic noise,
wherein the electrostatic noise detector detects electrostatic noise at a plurality of detection positions, and
the image forming apparatus further includes an electrostatic noise generation source estimator that estimates an electrostatic noise generation source that has generated electrostatic noise according to where the electrostatic noise has been detected from among the plurality of detection positions.

5. The image forming apparatus according to claim 1, further comprising
a plurality of electrostatic noise generation sources that generates electrostatic noise,
wherein the electrostatic noise detector detects an intensity of electrostatic noise, and
the image forming apparatus further includes an electrostatic noise generation source estimator that estimates an electrostatic noise generation source that has generated electrostatic noise according to the intensity of the electrostatic noise.

6. The image forming apparatus according to claim 1, further comprising:
a plurality of electrostatic noise generation sources that generates electrostatic noise; and
an electrostatic noise generation source estimator that estimates an electrostatic noise generation source that has generated electrostatic noise,
wherein the electrostatic noise detector includes a plurality of electrostatic noise detection parts provided in the apparatus,
the plurality of electrostatic noise detection parts includes electrostatic noise detection parts having different detection sensitivities, and
the electrostatic noise generation source estimator specifies an electrostatic noise generation source according to the detection sensitivity of the electrostatic noise detection part that has detected the electrostatic noise.

7. The image forming apparatus according to claim 3, further comprising
a storage that ranks and stores the electrostatic noise generation sources in an order of a possibility of erroneously detecting a change in the apparatus state due to generation of electrostatic noise.

8. The image forming apparatus according to claim 3, further comprising
a storage that stores a possibility of erroneously detecting a change in the apparatus state due to generation of electrostatic noise for each combination of the apparatus state and the electrostatic noise generation source,
wherein, when the state monitor detects the change in the apparatus state, the erroneous detection determiner determines that the change in the apparatus state is normally detected, in a case where the electrostatic noise generation source estimated by the electrostatic noise generation source estimator has no possibility of erroneously detecting the change in the apparatus state on the basis of a storage content of the storage.

9. The image forming apparatus according to claim 1, further comprising
a history recorder that records a history of a timing at which the electrostatic noise detector has detected the electrostatic noise.

10. The image forming apparatus according to claim 9,
wherein the history recorder further records a history of an intensity of the electrostatic noise detected by the electrostatic noise detector.

11. The image forming apparatus according to claim 9, further comprising
a concern level determiner that determines a concern level of the change in the apparatus state regarding a malfunction according to the history recorded by the history recorder and a magnitude of the change in the apparatus state monitored by the state monitor.

12. The image forming apparatus according to claim 1,
wherein a determination result by the erroneous detection determiner is displayed on an operation panel.

13. The image forming apparatus according to claim 1,
wherein a determination result by the erroneous detection determiner is transmitted to a data center.

14. The image forming apparatus according to claim 1,
wherein the apparatus state monitored by the state monitor is transmitted via a wiring on which electrostatic noise is superimposed.

15. The image forming apparatus according to claim 1,
wherein the wiring includes at least one of a wiring that transmits a detection signal of a sensor or a communication wiring.

16. The image forming apparatus according to claim 1,
wherein an electrostatic noise generation source includes at least one of an electrical contact point that generates electrostatic noise due to a contact failure or a motor that generates electrostatic noise due to a foreign matter.
